(19) United States
(12) Patent Application Publication
(10) Pub. No.: US 2018/0159415 A1
(43) Pub. Date: Jun. 7, 2018

(54) SWITCHED RELUCTANCE MACHINE (SRM) WITH PARALLEL FLUX PATH

(71) Applicant: Aditya Auto Products & Engg. (I) Pvt. Ltd., Bangalore (IN)

(72) Inventor: Srinivas KUDLIGI, Bangalore (IN)

(21) Appl. No.: 15/575,495

(22) PCT Filed: May 24, 2016
(86) PCT No.: PCT/IN2016/000132

§ 371 Date: Nov. 20, 2017

(30) Foreign Application Priority Data
May 25, 2015 (IN) 2596/CHE/2015

(51) Int. Cl. H02K 37/02; H02K 19/10; H02K 19/24; H02K 1/14; H02K 1/24; H02P 8/00; H02P 25/08

(52) U.S. Cl. CPC H02K 37/02; H02K 19/103; H02K 19/24; H02P 25/08; H02K 1/246; H02P 8/005; H02K 1/14

(57) ABSTRACT

A Switched Reluctance Machine (SRM) assembly is provided. The assembly comprises a stator with a plurality of stator poles with a coil wounded on each stator pole. Each of the plurality of stator poles comprises a plurality of sub-poles integrally formed therewith, and the plurality of sub-poles provide the closest interface between the stator and the rotor. Further, two coils of an opposing pair of stator poles are energized during an excitation phase which is configured to create a flux path between each of the plurality of opposing sub-poles of the energized stator poles. The rotor of the assembly comprises a plurality of poles extending from a surface to provide the closest interface between the rotor and stator. Further, the plurality of stator sub-poles and the plurality of rotor poles are arranged to provide a commutation angle for the SRM assembly less than 15 degrees.

### FIELD OF THE INVENTION

The present invention relates generally to the field of electric machines, including electric motors and generators. In particular, the present invention relates to a Switched Reluctance Machine (SRM) assembly which supports a commutation angle of less than 15 degrees. The SRM assembly includes a plurality of sub-poles on each stator pole, where two coils wound around an opposite pair of stator poles are energized during an excitation phase to obtain multiple parallel flux paths.

### BACKGROUND OF THE INVENTION

A Switched Reluctance Machine (SRM) is a rotating electrical machine including a stator and a rotor. SRMs are also known as variable reluctance machines, stepping motors and hybrid stepping motors which have linear or rotary motion. Typically, the stator is the outer stationary element that consists of a set of coils (for forming phases), each of which is wound on one stator pole. The rotor is mounted, inside the SRM and supported for rotation relative to the stator. The SRM is a doubly salient structure. Both the stator and the rotor have salient poles. The poles are typically fabricated with electrical grade laminated steel. On appropriate phase activation of the stator windings, the rotor tends to move into a position where the inductance of the excited stator winding is maximized, thereby generating torque. The movement is indicated as commutation angle, which represents the angle through which a particular phase, wound on a stator pole, when energized, brings a rotor pole into alignment with the stator pole of the phase. At this point of maximum inductance, the excited windings are de-energized and a subsequent set of windings (i.e. next phase) is excited. A circuit along with a sensor is provided for detecting the angular position of the rotor and for energizing the phase windings as a function of the rotor's position.

The construction or design of SRMs seek to extract the maximum torque with higher efficiency. Various modifications to the designs have been made to achieve this objective. For SRMs with smaller commutation angle (for example, less than 15 degrees), one technique known in the art to achieve higher torque includes increasing number of poles on the stator and the rotor. This arrangement results in higher torque roughly proportional to extent to which the commutation angle is reduced. However, this increases the number of commutations per rotation. Furthermore, more than two coils per phase require activation in a phase. Providing for more coils per phase decreases the area available per coil. This increases the electrical resistance of each of the coils and of the phase. Additionally, the coils now have to be connected in series or in parallel. Where coils are connected in series, the input voltage requirement increases, and where connected in parallel, the input current increases to achieve the desired power levels. In either of the two approaches in conventional methods (for commutation angle less than 15 degrees), the increased number of coils per phase results in increased impedance, reduced power levels and inherently limited dynamic performance.

In light of the above, there is a need for an SRM with the least number of coils per phase for angles of commutation less than 15 degrees. Further, there is a need for an efficient design of an SRM which produces higher torque and torque densities with increased efficiency while operating at lower commutation angles.

### SUMMARY OF THE INVENTION

A Switched Reluctance Machine (SRM) assembly is provided. In various embodiments of the present invention, the assembly comprises a stator having a plurality of stator poles which are substantially angularly equally disposed. A surface of the stator interfaces with a rotor defining equal spaces between any of two adjacent stator poles. The plurality of stator poles comprise a plurality of sub-poles integrally formed therewith, and the plurality of sub-poles provide the closest interface between the stator and rotor. Further, each stator pole comprises a coil with multiple turns wound thereon, wherein two stator coils wound around an opposing pair of stator poles are energized during an excitation phase which is configured to create a flux path between each of the plurality of opposing sub-poles of the energized stator poles of the SRM assembly. The SRM assembly further comprises the rotor positioned with a means to provide for rotation. The rotor comprises a plurality of rotor poles extending from a surface to provide the closest interface between the rotor and stator such that an air-gap is created in between the stator sub-poles and the rotor poles. Further, the plurality of stator sub-poles and the plurality of rotor poles are arranged to provide a commutation angle for the SRM assembly less than 15 degrees.

In an embodiment of the present invention, the SRM assembly comprises an outer stator comprising a substantially cylindrical inner surface having a plurality of inwardly extending stator poles which are substantially angularly equally disposed. The inner surface of the stator has equal spaces between any of two adjacent stator poles. Further, the plurality of stator poles comprises a plurality of sub-poles integrally formed therewith and disposed radially inwards. Each stator pole comprises a coil with multiple turns wound thereon. Furthermore, two stator coils wound around an opposing pair of stator poles are energized during an excitation phase which is configured to create a flux path between each of the plurality of opposing sub-poles of the energized stator poles of the SRM assembly. In this embodiment of the present invention, the SRM assembly further comprises an inner rotor positioned with a means to provide for rotation and maintain concentricity with the cylindrical hollow defined by the surface of the stator poles. The rotor comprises a plurality of rotor poles extending outwardly from an outer surface thereof such that an air-gap is created in between the inwardly extending stator sub-poles and the outwardly extending rotor poles. Further, the plurality of stator sub-poles and the plurality of rotor poles are arranged to provide a commutation angle for the SRM assembly less than 15 degrees.

In another embodiment of the present invention, the SRM assembly comprises an inner stator comprising a substantially cylindrical outer surface having a plurality of outwardly extending stator poles which are substantially angularly equally disposed. The outer surface of the stator has equal spaces between any of two adjacent stator poles. Further, the plurality of stator poles comprise a plurality of sub-poles integrally formed therewith and disposed radially outward. Each stator pole comprises a coil with multiple turns wound thereon. Furthermore, two stator coils wound around an opposing pair of stator poles are energized during an excitation phase which is configured to create a flux path between each of the plurality of opposing sub-poles of the energized stator poles of the SRM assembly. In this embodiment of the present invention, the SRM assembly further comprises an outer rotor having a plurality of inwardly projected poles. The plurality of rotor poles thereby defining a hollow cylindrical inner space. Further, the plurality of stator sub-poles and the rotor poles are arranged to provide a commutation angle for the SRM assembly less than 15 degrees.

In various embodiments of the present invention, the flux path created between each of the plurality of opposing sub-poles of the energized opposing pair of stator poles comprises of substantially parallel flux paths for flux transiting in air between the energized pair of stator poles.

In various embodiments of the present invention, the product of number of sub-poles on each stator pole, the desired angle of commutation, and number of phases required in the operation of the SRM assembly is less than three sixty degrees divided by number of stator poles.

In various embodiments of the present invention, three hundred and sixty degrees divided by the product of the number of phases and the desired angle of commutation is equal to number of rotor poles in the assembly.

In an embodiment of the present invention, the plurality of stator poles and the plurality of rotor poles are structured in the SRM assembly by increasing the required angle of commutation with an additional angle value. The additional angle value facilitates dissipation of energy stored in an off going energized' phase by free-wheeling the off going energized phase.

In another embodiment of the present invention, the plurality of stator sub-poles and the plurality of rotor poles are designed into multiple shapes to achieve a higher torque during operation of the SRM assembly.

In yet another embodiment of the present invention, the SRM assembly is designed to work with three phases. Each sub-pole subtends an angle of commutation at the centre of the SRM assembly. In this embodiment of the present invention, the spacing between a pair of adjacent sub-poles of the plurality of sub-poles at a stator pole is two times the angle of commutation subtended by each of the sub-pole.

In yet another embodiment of the present invention, the SRM assembly is designed to work with four phases. Each sub-pole subtends an angle of commutation at the centre of the SRM assembly. In this embodiment of the present invention, the spacing between a pair of adjacent sub-poles of the plurality of sub-poles at a stator pole is three times the angle of commutation subtended by each of the sub-pole.

In an embodiment of the present invention, the SRM assembly is operated as a motor. In another embodiment of the present invention, the SRM assembly is operated as a generator. In yet another embodiment of the present invention, the SRM assembly is operated as a combination of a motor and a generator.

In an embodiment of the present invention, the SRM assembly is designed to operate as a sensor-less SRM. In another embodiment of the present invention, the SRM assembly is designed to operate with a sensor.

In various embodiments of the present invention, the SRM assembly is designed to achieve greater material utilization by constructing a plurality of interlocked circumferentially-spaced stator segment assemblies with a stator segment core and winding wire wound or placed around each of the plurality of stator poles, wherein the rotor surface assemblies are segmented.

In various embodiments of the present invention, a Switched Reluctance Machine (SRM) assembly which is designed to work with three phases is provided. The SRM assembly comprises a stator comprising a plurality of stator poles which are substantially angularly equally disposed. A surface of the stator interfaces with a rotor defining equal spaces between any of two adjacent stator poles. Further, the plurality of stator poles comprises a plurality of sub-poles integrally formed therewith. The plurality of sub-poles provide the closest interface between the stator and rotor. Furthermore, each stator pole comprises a coil with multiple turns wound thereon. Each sub-pole subtends an angle of commutation at the centre of the SRM assembly. Still further, the spacing between a pair of adjacent sub-poles of the plurality of sub-poles at a stator pole is two times the angle of commutation subtended by each of the sub-pole. The SRM assembly further comprises the rotor comprising a plurality of rotor poles extending from a surface to provide the closest interface between the rotor and stator.

In various embodiments of the present invention, a Switched Reluctance Machine (SRM) assembly which is designed to work with four phases is provided. The SRM assembly comprises a stator comprising a plurality of stator poles which are substantially angularly equally disposed. A surface of the stator interfaces with a rotor defining equal spaces between any of two adjacent stator poles. Further, the plurality of stator poles comprise a plurality of sub-poles integrally formed therewith. The plurality of sub-poles providing the closest interface between the stator and rotor. Furthermore, each sub-pole subtends an angle of commutation at the centre of the SRM assembly. Still further, the spacing between a pair of adjacent sub-poles of the plurality of sub-poles at a stator pole is three times the angle of commutation subtended by each of the sub-pole. The SRM assembly further comprises the rotor comprising a plurality of rotor poles extending from a surface to provide the closest interface between the rotor and stator.

It is to be understood that both the foregoing general description and the following details description are exemplary arid explanatory and are intended to provide further explanation of the invention as claimed.

### BRIEF DESCRIPTION OF THE DRAWINGS

The present invention is described by way of embodiments illustrated in the accompanying drawings wherein:

FIG. 1(a) illustrates a cross section of a regular switched reluctance machine, according to one embodiment of the present invention.

FIG. 1(b) illustrates a representation of the flux plot for the regular switched reluctance machine, according to one embodiment of the present invention.

FIG. 2(a) illustrates a cross section of an inverted switched reluctance machine, according to one embodiment of the present invention.

FIG. 2(b) illustrates a representation of the flux plot for the inverted switched reluctance machine, according to one embodiment of the present invention.

FIG. 3(a) illustrates a cross section of a regular switched reluctance machine, according to one embodiment of the present invention.

FIG. 3(b) illustrates a representation of the flux plot for the regular switched reluctance machine, according to one embodiment of the present invention.

FIG. 4(a) illustrates a cross section of an inverted switched reluctance machine, according to one embodiment of the present invention.

FIG. 4(b) illustrates a representation of the flux plot for the inverted switched reluctance machine, according to one embodiment of the present invention.

FIG. 5 illustrates a representation of shaping of the rotor pole and stator sub-poles, according to one embodiment of the present invention.

FIG. 6 illustrates an exemplary representation of shaping of the rotor pole and stator sub-poles, according to one embodiment of the present invention.

FIG. 7 illustrates a representation of the segmented stator and rotor assemblies, according to one embodiment of the present invention.

FIGS. 8(a)-8(e) illustrate a representation of variation in the flux plot corresponding to a phase, at the start of commutation for anticlockwise rotation of the rotor of an SRM, according to one embodiment of the present invention.

### DETAILED DESCRIPTION OF THE INVENTION:

Reference will now be made in detail to the description of the present subject matter, multiple examples of which are shown in figures. Each embodiment is provided to explain the subject matter and not a limitation. These embodiments are described in sufficient detail to enable a person skilled in the art to practice the invention, and it is to be understood that other embodiments may be utilized and that logical, physical, and other changes may be made within the scope of the embodiments. The following detailed description is, therefore, not be taken as limiting the scope of the invention, but instead the invention is to be defined by the appended claims.

Throughout the specification, the term “regular SRM” along with its semantic variants in the embodiments refers to a machine which comprises outer stator and inner rotor. Further, the term “inverted SRM” along with its semantic variants in the embodiments refers to a machine which comprises outer rotor and inner stator.

In various embodiments of the present invention, a Switched Reluctance Machine (SRM) assembly comprises a stator and a rotor. The stator has stator poles which are, substantially angularly equally disposed. A surface of the stator interfaces with the rotor defining equal spaces between any of two adjacent stator poles. Each stator pole comprises a plurality of sub-poles. The sub-poles are indentations formed at each of the stator poles. In particular, a stator pole may be divided into sub-poles such that each of the sub-poles are provided on the periphery of each of the stator pole. The sub-poles are spaced apart in a pre-determined manner so as to provide air space in between. The extreme surface of the sub-poles define the circumference of the stator pole when rotated. A sub-pole may be preferably provided integrally to the stator pole.

Further, the plurality of sub-poles provide the closest interface between the stator and rotor. The rotor is positioned with a means to provide for rotation. The rotor comprises a plurality of rotor poles that extend from a surface to provide the closest interface between the rotor and stator such that an air-gap is created in between the stator poles and the rotor poles.

The plurality of stator sub-poles and the plurality of rotor poles are arranged to provide a commutation angle for the SRM assembly less than 15 degrees. Each stator pole comprises a coil with multiple turns wound thereon. During an excitation phase, two stator coils wound around an opposing pair of stator poles are energized. A flux path is therefore created between each of the opposing sub-poles of the energized stator poles of the SRM assembly.

In an embodiment of the present invention, a Switched Reluctance Machine (SRM) assembly comprises an outer stator and an inner rotor. The outer stator comprises of electrical grade laminated steel. Further, the outer stator comprises of substantially cylindrical inner surface having a plurality of inwardly extending stator poles, which are substantially angularly equally disposed. A plurality of sub-poles are provided at each of the stator poles and disposed radially inwardly, such that the stator's inner surface has equal spaces between each of the radially projected inner poles. The inner rotor comprises of electrical grade laminated steel and has a plurality of outwardly extending rotor poles that are provided on the outer surface thereof. The rotor is positioned with a means to provide for rotation with respect to the stator and maintain concentricity with the cylindrical hollow defined by the inner surface of the stator sub-poles. An air-gap is provided in between the inwardly extending stator sub-poles and the outwardly extending rotor poles. In this embodiment of the present invention, the number of stator poles, stator sub-poles and rotor poles are selected such that a commutation angle of less than 15 degrees is provided for the SRM assembly. In an exemplary embodiment of the present invention, upon energization of a phase in the SRM, i.e. energization of two opposite poles of the stator, a parallel flux path is created. The term “parallel flux path” refers to multiple flux lines transiting in air between pairs of corresponding sub-poles of the two energized opposite stator poles. The plurality of sub-poles formed at a stator pole are energized by the coil wound around the stator pole. The configuration of the SRM assembly in accordance with this embodiment of the present invention provides for utilization of essentially two stator coils when a phase is activated. For example, if each stator pole of the SRM includes three sub-poles, and two opposite stator poles are energized during a phase activation, a flux path/lines between each sub-pole of the first stator pole and the corresponding sub-pole of the second stator pole is created. These flux paths between the sub-poles of the stator poles are parallel in orientation, thereby termed as “parallel flux path”. The parallel flux path in the SRM assembly facilitates in producing high torque and torque densities with an increased efficiency by operating at a commutation angle lesser than 15 degrees where a phase excitation is performed using a maximum of two stator coils.

In another embodiment of the present invention, a Switched Reluctance Machine (SRM)—assembly comprises an outer rotor and an inner stator. The inner stator comprises of electrical grade laminated steel. Further, the inner stator comprises of substantially cylindrical outer surface with a plurality of outwardly extending stator poles which are substantially angularly equally disposed. A plurality of sub-poles are provided at each of the stator poles disposed radially outwardly. The stator outer surface has equal spaces between each of the radially outwardly projected poles. Each stator pole is provided with a coil of multiple turns wounded thereon. The outer rotor comprises of electrical grade laminated steel with a plurality of inwardly projecting poles that are provided on the inner surface thereof. The surfaces of rotor poles define a hollow cylindrical inner space. The rotor is provided with a means of rotation with respect to the stator and maintaining concentricity between the outer rotor and inner stator. An air-gap is provided in between the inwardly extending rotor poles and the outwardly extending stator sub-poles. In this embodiment of the present invention, the number of stator poles, stator sub-poles and the rotor poles are selected such that a commutation angle of less than 15 degrees is provided for the SRM assembly. In an exemplary embodiment of the present invention, upon energization of a phase in the SRM, i.e. energization of two opposite poles of the stator, a parallel flux path is created. The configuration of the SRM assembly in accordance with this embodiment of the present invention provides for utilization of essentially two stator coils when a phase is activated. In various embodiments of the present invention, the SRM assembly is designed to work with three phases or four phases.

In various embodiments of the present invention, the invented SRM assembly uses only two coils per phase which results in low magneto-motive force (MMF) requirement, thus resulting in better dynamic performance. This implementation strategy results in reduced torque ripple. The invented SRM while operating at lesser commutation angle, outputs significantly high torque and torque densities. The energy reuse at the aligned condition of the rotor and stator poles reduces complexities of energy management, torque ripple and improves efficiency. Additionally, the invented SRM assembly is designed to support a higher angle of commutation that results in positive torque generation by freewheeling the phase through the angle of motion in excess of the required commutation angle. It provides the advantage of elimination of negative torque generated, by an off going phase. The energy of the off going phase is generally utilized made by freewheeling a part of a phase. This leads to the advantage of a reduction in the torque ripple of the SRM. These distinct advantages are obtained with no addition of active control variables. The invented SRM assembly is suitable for all motor and generator applications in general and yet more preferred in applications that require brushless operations, where any one or more of speed, torque and power needs to be regulated. It may be considered as an alternative to Brushless DC (BLDC) motors and induction motors.

In various embodiments of the present invention, the commutation angle supported by the SRM assembly may be larger than the required angle of commutation. The additional angle of commutation serves to supplement the sequentially adjacent phase in producing torque while dissipating the energy stored in the off going phase by free-wheeling the off going phase.

In various embodiments of the present invention, the SRM, assembly may be designed to achieve a high torque profile by providing alternative construction for shaping the stator sub-poles and rotor poles. Embodiments of the SRM assembly may be operated as a motor or generator or a combination of motor and generator.

In another embodiment of the present invention, the SRM assembly may be designed to achieve greater material utilization by constructing a plurality of interlocked circumferentially-spaced stator segment assemblies with a stator segment core and winding wire wound or around the stator pole, and the rotor surface assemblies may be segmented. In an embodiment of the present invention, the SRM assembly may be operated either with or without the use of sensors for sensing rotor's position during phase activation.

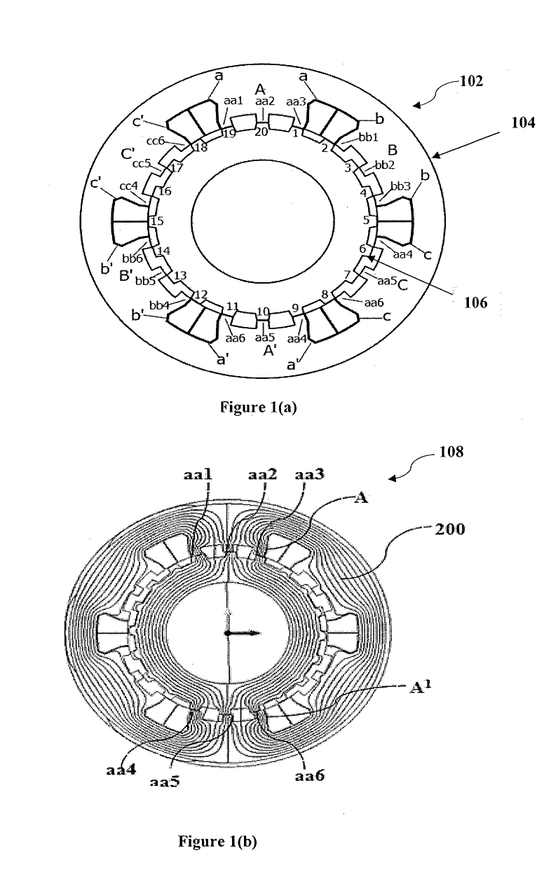

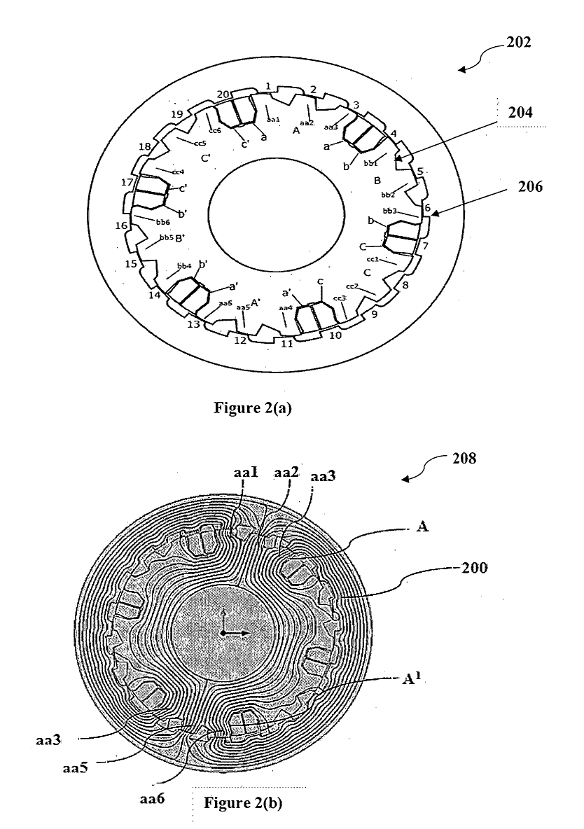

FIG. 1(a) illustrates a cross section of a regular switched reluctance machine (SRM) assembly 102, according to one embodiment of the present invention. The SRM assembly 102 comprises an outer stator 104 which is made of, for example, but not limited to, electrical grade laminated steel. The inner surface of the stator 104 is substantially cylindrical having six stator poles A, A¹, B, B¹, C and C¹ (collectively referred to as A-C¹) extending radially inward thereof. The stator poles A-C¹ are substantially angularly equally disposed and a coil with multiple turns is wound around each of the stator poles A-C¹. Further, a plurality of sub-poles are disposed at each of the stator poles A-C¹. In an exemplary embodiment of the present invention, each of the stator poles A-C¹ comprise of three sub-poles provided at the respective stator poles, which are disposed radially inwardly. As illustrated in FIG. 1(a), aa1, aa2 and aa3 are sub-poles of stator pole A, aa4, aa5 and aa6 are sub-poles of A¹, bb1, bb2 and bb3 are sub-poles of B, bb4, bb5 and bb6 are sub-poles of B¹, cc1, cc2 and cc3 are sub-poles of C and cc4, cc5 and cc6 are sub-poles of C¹ respectively. The stator poles are arranged substantially equidistant along the stator 104's inner surface, i.e. every two adjacent stator poles have equal recess between them. In this exemplary embodiment of the present invention, the SRM assembly 102 is designed to work with three phases. A pair of opposite stator poles constitutes to work for each phase, i.e. the stator poles pair A and A¹ constitute for first phase, B and B¹ constitute for second phase and C and C¹ constitute for third phase respectively. Further, each phase consists of two coils, i.e., a and a¹ for first phase, b and b¹ for second phase and c and c¹ for third phase respectively. Additionally, the SRM assembly 102 comprises an inner rotor 106 which is made of, for example, but not limited to, electrical grade laminated steel. The rotor 106 has a substantially cylindrical hollow outer space defined by the inner surface of the stator poles, and further the rotor 106 comprises twenty rotor poles 1 to 20 projected radially outward from the outer surface thereof. An air-gap is created in between the inwardly extending sub-poles of the stator poles A-C¹ and the outwardly extending rotor poles 1 to 20. In this exemplary embodiment of the present invention, the SRM assembly 102 is designed with 6 degrees commutation angle. The selection of number of the stator poles A-C¹ and the rotor poles 1 to 20 in combination with the commutation angle is described later in the specification.

FIG. 1(b) illustrates a representation 108 of the flux plot for the regular switched reluctance machine (SRM) assembly 102 (shown in FIG. 1(a)), according to an embodiment of the present invention. The representation 108 of the flux plot shows that SRM assembly 102 (shown in FIG. 1(a)) uses 2 stator poles A and A¹ out of the 6 stator poles A-C¹, i.e. 2 stator poles A and A¹ are excited during an active period of an appropriate phase. During excitation period, the flux path 200 passes through three sub-poles aa1, aa2 and aa3 of the stator pole A and three sub-poles aa4, aa5 and aa6 of the stator pole A¹ in a parallel manner. In this exemplary embodiment of the present invention, the commutation angle is 6 degrees.

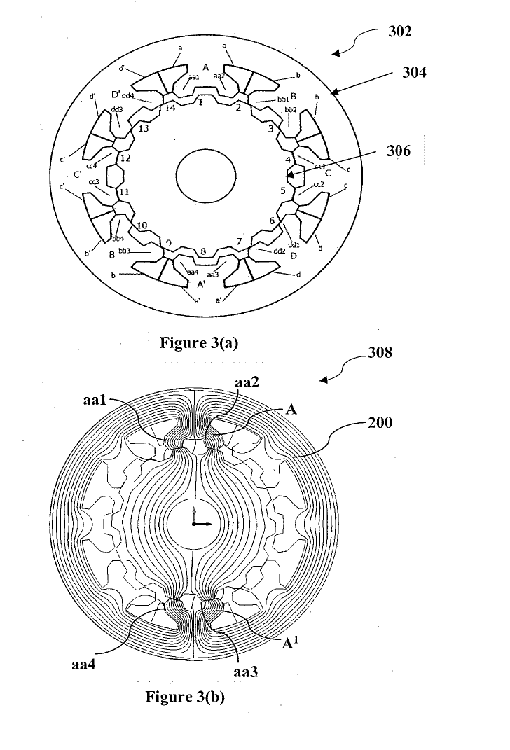

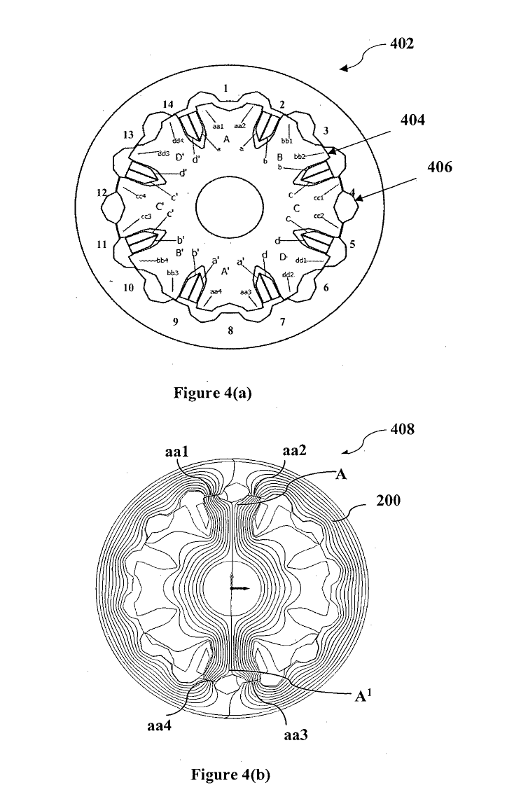

FIG. 2(a) illustrates a cross section of an inverted switched reluctance machine (SRM) assembly 202, according to one embodiment of the present invention. The SRM assembly 202 comprises an inner stator 204 which is made of, for example, but not limited to, electrical grade laminated steel. The outer surface of the stator 204 is substantially cylindrical having six stator poles A, A¹, B, B¹, C and C¹ (collectively referred to as A-C¹) extending radially outward thereof. The stator poles A-C are substantially angularly equally disposed and a coil with multiple turns is wound around each of the stator poles A-C¹. Further, a plurality of sub-poles are disposed at each of the stator poles A-C¹. In an exemplary embodiment of the present invention, each stator pole A-C¹ comprises three sub-poles provided at the respective stator poles, and disposed radially outwardly. As illustrated in FIG. 2(a), aa1, aa2 and aa3 are sub-poles of stator pole A, aa4, aa5 and aa6 are sub-poles of A¹, bb1, bb2 and bb3 are sub-poles of B, bb4, bb5 and bb6 are sub-poles of B¹, cc1, cc2 and cc3 are sub-poles of stator pole C and cc4, cc5 and cc6 are sub-poles of stator pole C¹ respectively. In this exemplary embodiment of the present invention, the SRM assembly 202 is designed to work with three phases. A pair of opposite stator poles constitute to work for each phase, i.e. the stator poles pair A and A¹ constitute for first phase, B and B¹ constitute for second phase and C and C¹ constitute for third phase respectively. Further, each phase consists of two coils wound around the stator poles A-C¹, i.e., a and a¹ for first phase, b and b¹ for second phase and c and c¹ for third phase respectively. Additionally, the SRM assembly 202 comprises an outer rotor 206 which is made of, for example, but not limited to, electrical grade laminated steel. The rotor 206 comprises twenty rotor poles 1 to 20 projected radially inward from the inner surface thereof. The outermost surfaces of the rotor poles may be provided with, for example, a curvature, thereby defining a substantially hollow cylindrical inner space. In this exemplary embodiment of the present invention, the SRM assembly 202 is designed with 6 degrees commutation angle. The selection of number of the stator poles A-C¹ and the rotor poles 1 to 20 in combination with the commutation angle is described later in the specification.

FIG. 2(b) illustrates a representation 208 of the flux plot for the inverted switched reluctance machine (SRM) assembly 202 (shown in FIG. 2(a)), according to an embodiment of the present invention. The representation 208 of the flux plot shows that the SRM 202 (shown in FIG. 2(a)) uses 2 stator poles A and A¹ out of the 6 stator poles A-C¹ i.e. 2 stator poles A and A¹ are excited during an active period of an appropriate phase. During excitation period, the flux path 200 passes through three sub-poles aa1, aa2 and aa3 of the stator pole A and three sub-poles aa4, aa5 and aa6 of the stator pole A¹ in a parallel manner. In this embodiment of the present invention, the commutation angle is 6 degrees.

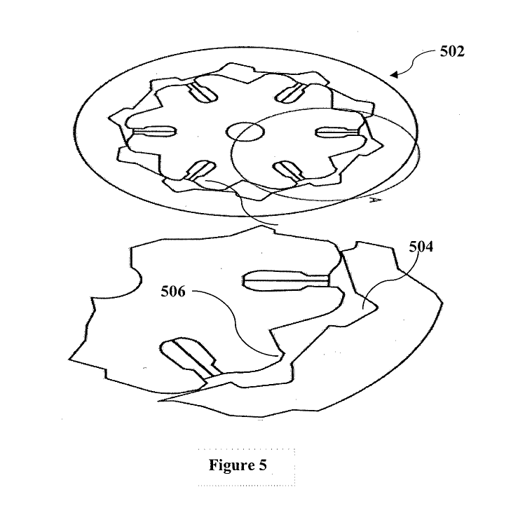

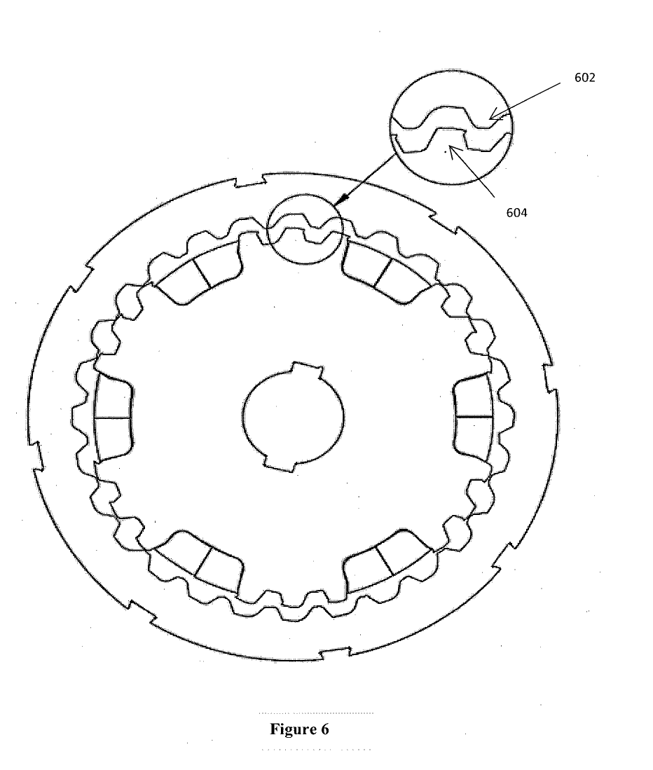

FIG. 3(a) shows a cross section of a regular switched reluctance machine (SRM) assembly 302, according to another embodiment of the present invention. The SRM assembly 302 comprises an outer stator 304 which is made of, for example, but not limited to, electrical grade laminated steel. The inner surface of the stator 304 is substantially cylindrical having eight stator poles A, A¹, B, B¹, C, C¹, D and D¹ (collectively referred to as A-D¹) extending radially inward thereof. The stator poles A-D¹ are substantially angularly equally disposed and a coil with multiple turns is wound around each of the stator poles A-D¹. Further, a plurality of sub-poles are disposed at each of the stator poles A-D¹. In an exemplary embodiment of the present invention, each of the stator poles A-D¹ comprises of two sub-poles placed at the respective stator poles, and disposed radially inwardly. As illustrated in FIG. 3(a), aa1 and aa2 are sub-poles of stator pole A, aa3 and aa4 are sub-poles of stator pole A¹, bb1 and bb2 are sub-poles of stator pole B, bb3 and bb4 are sub-poles of stator pole B¹, cc1 and cc2 are sub-poles of stator pole C, cc3 and cc4 are sub-poles of stator pole C¹, dd1 and dd2 are sub-poles of stator pole D and dd3 and dd4 are sub-poles of stator pole D¹ respectively. The stator poles A-D¹ are arranged substantially equidistant along the stator 304's inner surface, i.e. every two adjacent stator poles have equal recesses between them. In this embodiment of the present invention, the SRM assembly 302 is designed to work with four phases. A pair of opposite stator poles constitutes to work for each phase i.e. the stator poles pair A and A¹ constitute for first phase, B and B¹ constitute for second phase, C and C¹ constitute for third phase and D and D¹ constitute for fourth phase respectively. Further, each phase consists of two coils, i.e., a and a¹ for first phase, b and b¹ for second phase, c and c¹ for third phase and d and d¹ for fourth phase respectively. Additionally, the SRM assembly 302 comprises an inner rotor 306 which is made of, for example, but not limited to, electrical grade laminated steel. The rotor 306 has a substantially cylindrical hollow outer space defined by the inner surface of the stator poles, and further the rotor comprises fourteen rotor poles 1 to 14 projected radially outward from the outer surface thereof. An air-gap is created in between the inwardly extending sub-poles of the stator poles A-D¹ and the outwardly extending rotor poles 1 to 14. In this embodiment of the present invention, the SRM 302 is designed with 6.42 degrees commutation angle. The selection of number of the stator poles A-D¹ and the rotor poles 1 to 14 in combination with the commutation angle is described later in the specification.

FIG. 3(b) illustrates a representation 308 of the flux plot for the regular switched reluctance machine (SRM) assembly 302 (shown in FIG. 3(a)), according to one embodiment of the present invention. The representation 308 of the flux plot shows that the SRM assembly 302 uses 2 stator poles A and A¹ out of the 8 stator poles A-D¹, i.e. 2 stator poles A and A¹ are excited during an active period of an appropriate phase. During excitation period, the flux path 200 passes through two sub-poles aa1 and aa2 of the stator pole A and two sub-poles aa3 and aa4 of the stator pole A¹ in a parallel manner. In this embodiment of the present invention, the commutation angle is 6.42 degrees.

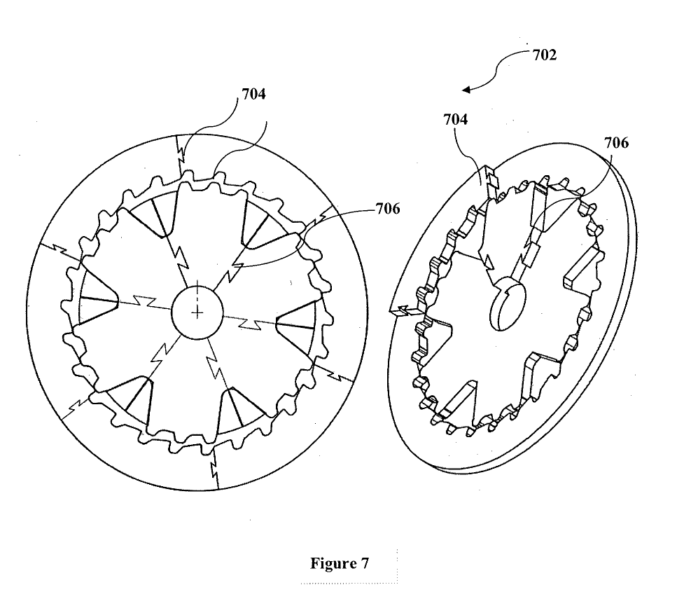

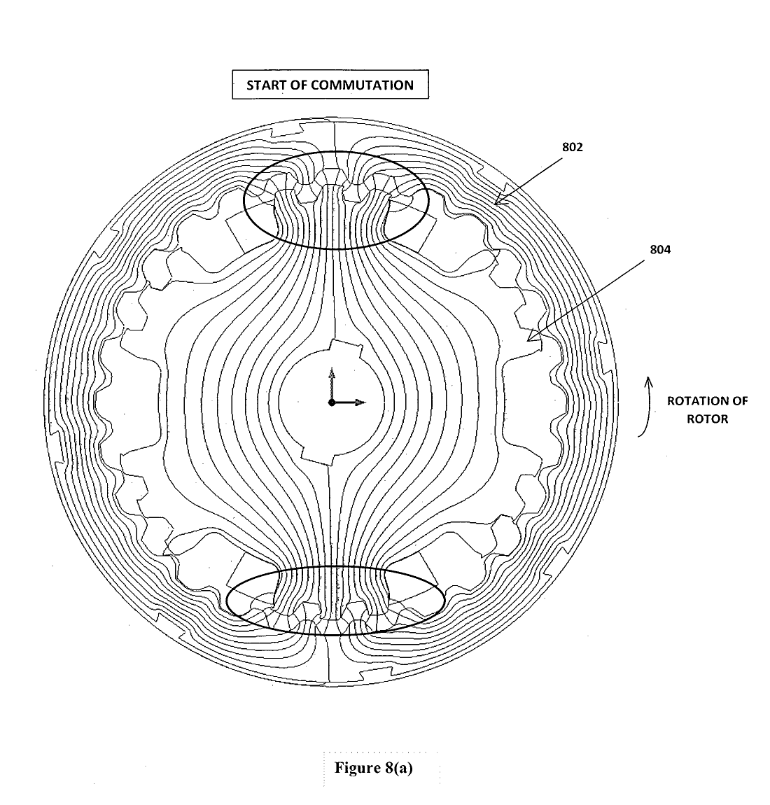

FIG. 4(a) illustrates a cross section of an inverted switched reluctance machine (SRM) assembly 402, according to another embodiment of the present invention. The SRM assembly 402 comprises an inner stator 404 which is made of, for example, but not limited to, electrical grade laminated steel. The outer surface of the stator 404 is substantially cylindrical having eight stator poles A, A¹, B, B¹, C, C¹ D and D¹ (collectively referred to as A-D¹) extending radially outward thereof. The stator poles A-D¹ are substantially angularly equally disposed and a coil is wound around each of the stator poles A-D¹. Further, a plurality of sub-poles are disposed at each of the stator poles A-D¹. In an exemplary embodiment of the present invention, each stator pole A-D¹ comprises two sub-poles provided at the respective stator poles and disposed radially outwardly. As illustrated in FIG. 4(a), aa1 and aa2 are sub-poles of stator pole A, aa3 and aa4 are sub-poles of stator pole A¹, bb1 and bb2 are sub-poles of stator pole of B, bb3 and bb4 are sub-poles of stator pole B¹, cc1 and cc2 are sub-poles of stator pole C, cc3 and cc4 are sub-poles of stator pole C¹, dd1 and dd2 are sub-poles of stator pole D and dd3 and dd4 are sub-poles of stator pole D¹ respectively. In this embodiment of the present invention, the SRM assembly 402 is designed to work with four phases. A pair of opposite stator poles constitutes to work for each phase, i.e. the stator poles, pair A and A¹ constitute for first phase, B and B¹ constitute for second phase, C and C¹ constitute for third phase and D and D¹ constitute for fourth phase respectively. Further, each phase consists of two coils wound around the stator poles A-D¹, i.e. a and a¹ for first phase, b and b¹ for second phase, c and c¹ for third phase and d and d¹ for fourth phase respectively. Additionally, the SRM assembly 402 comprises an outer rotor 406 which is made of, for example, but not limited to, electrical grade laminated steel. The rotor 406 comprises fourteen rotor poles 1 to 14 projected radially inwardly from the inner surface thereof. The outermost surfaces of the rotor poles may be provided with, for example, a curvature, thereby defining a substantially hollow cylindrical inner space. In this embodiment of the present invention, the SRM assembly 402 is designed with 6.42 degrees commutation angle. The selection of number of the stator poles A-D¹ and the rotor poles 1 to 14 in combination with the commutation angle is described later in the specification.

FIG. 4(b) illustrates a representation 408 of the flux plot for the inverted switched reluctance machine (SRM) assembly 402 (shown in FIG. 4(a)), according, to one embodiment of the present invention. The representation 408 of the flux plot shows that the SRM assembly 402 (shown in FIG. 4(a)) uses 2 stator poles A and A¹ out of 8 stator poles A-D¹ i.e. 2 stator poles A and A¹ are excited during an active period of an appropriate phase. During excitation period, the flux path 200 passes through two sub-poles aa1 and aa2 of the stator pole A and two sub-poles aa3 and aa4 of the stator pole A¹ in a parallel manner. In this embodiment of the present invention, the commutation angle is 6.42 degrees.

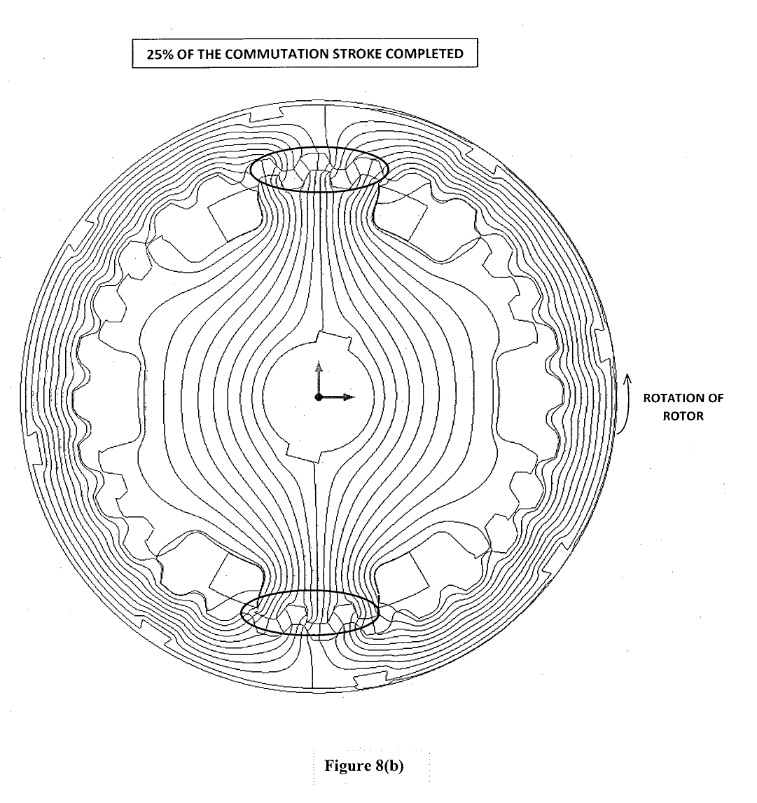

FIG. 5 illustrates a representation 502 of shaping of a rotor pole and stator sub-poles, according to one embodiment of the present invention. The rotor poles 504 and stator sub-poles 506 are designed into multiple shape modifications to achieve a high torque profile. In particular, the rotor poles 504 and the stator sub-poles 506 are shaped in a manner so as to provide a higher torque in a desired direction. In this embodiment of the present invention, the stator sub-poles 506 may be provided such that all poles are not equidistant from the inner surface of rotor poles 504. Further, in this embodiment of the present invention, the trailing end of a stator sub-pole 506 is shaped such that it has a tapering inwardly, such that the air gap between the stator sub-pole 506 and the rotor pole 504 at the trailing edge is larger than the air gap at the leading point. The leading edge of the stator sub-pole 506 is shaped such that the surface of the pole closest to the rotor poles is removed from the leading edge. Additionally, the leading edge of the stator sub-pole 806 provides for a larger air gap with the rotor pole than the trailing edge, such that when the stator sub-pole 506 and the rotor pole 504 are perfectly aligned, the air gap between the trailing end of the stator sub-pole 506 and the leading edge of the rotor pole 504 is widest, and the leading surface of the stator-sub-pole 506 and the trailing end of the rotor pole 504 define the smallest air gap.

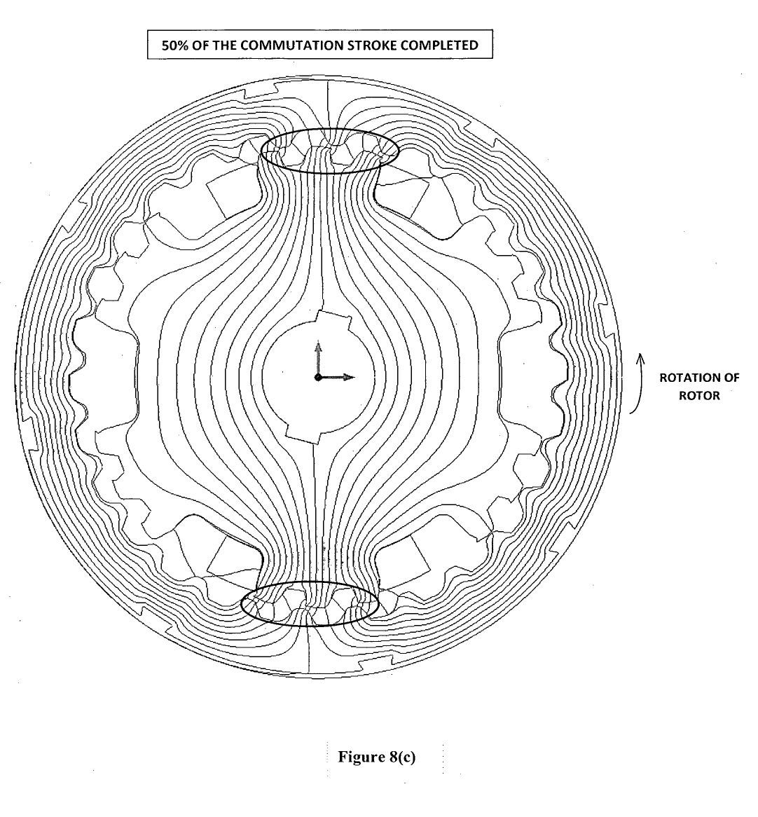

FIG. 6 illustrates an exemplary representation of shaping of stator sub-poles 602 and rotor poles 604, according to one embodiment of the present invention. In this exemplary embodiment of the present invention, the stator sub-poles 602 and the rotor poles 604 are designed with chamfer and fillet edges. Once a phase is activated, the exemplary shape of each of the stator poles 602 and each of rotor poles 604 ensure maximum saturation of magnetic flux and additionally, minimizes any back linking of magnetic flux with respect to the rotor poles 604 which is in phase-out. Further, the exemplary chamfer and fillet edges of the stator poles 602 and the rotor poles 604 shape the flux path in a manner which maximizes tangential component, and thereby resulting in better torque generation. This is explained hereinafter.

The force that is generated between the rotor and stator is on account of the flux in the airgap between the stator poles 602 and the rotor poles 604. Further, the net direction of the flux is the net direction of the force generated. The generated force can be resolved into radial and tangential directions. While the radial component does not generate any torque, the tangential component is multiplied by the radius to generate the torque. Hence, the shaping of the stator poles 602 and the rotor poles 604 to produce maximum tangential flux results in better torque generation.

Additionally, when the stator poles 602 and the rotor poles 604 are in alignment, all the flux is radial while the tangential component is zero. Hence, the torque produced is zero. It is another objective of the present invention to increase the flux in the commutation region where there is significant tangential component, and in the angles close to alignment where the tangential component is low. This is used to freewheel the phase thus releasing the energy stored while delivering positive torque. The shaping of the stator poles 602 and the rotor poles 604 using chamfers and fillets assist in achieving this objective.

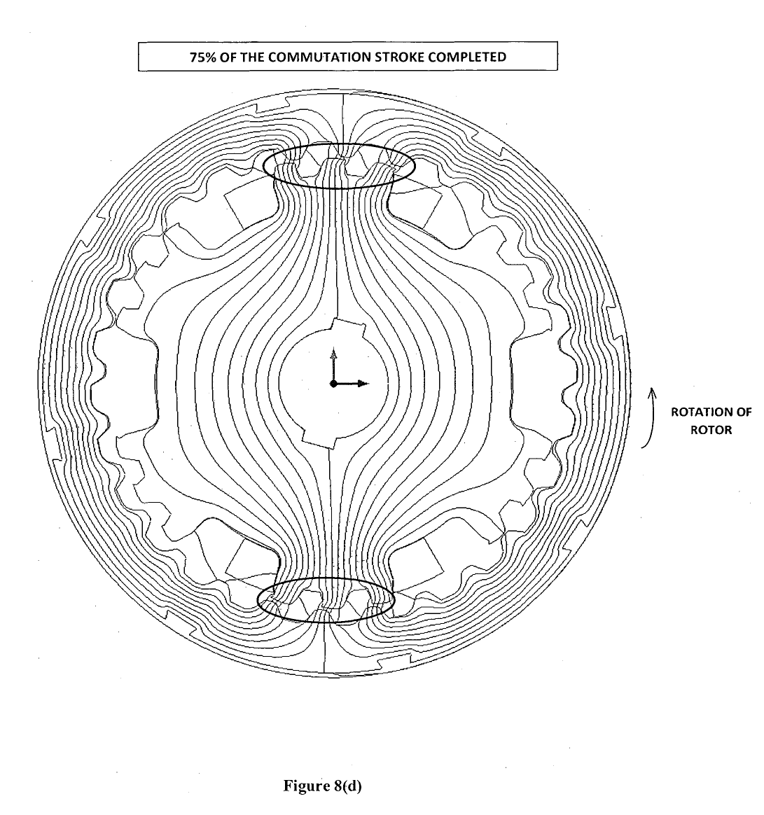

FIG. 7 illustrates a representation 702 of the segmented stator and rotor assemblies, according to an embodiment of the present invention. In the present embodiment, each stator assembly 706 and rotor assembly 704 is segmented. The segmented stator 706 and rotor 704 assemblies are circumferentially interlocked. The segmented stator and rotor assemblies achieve greater material utilization.

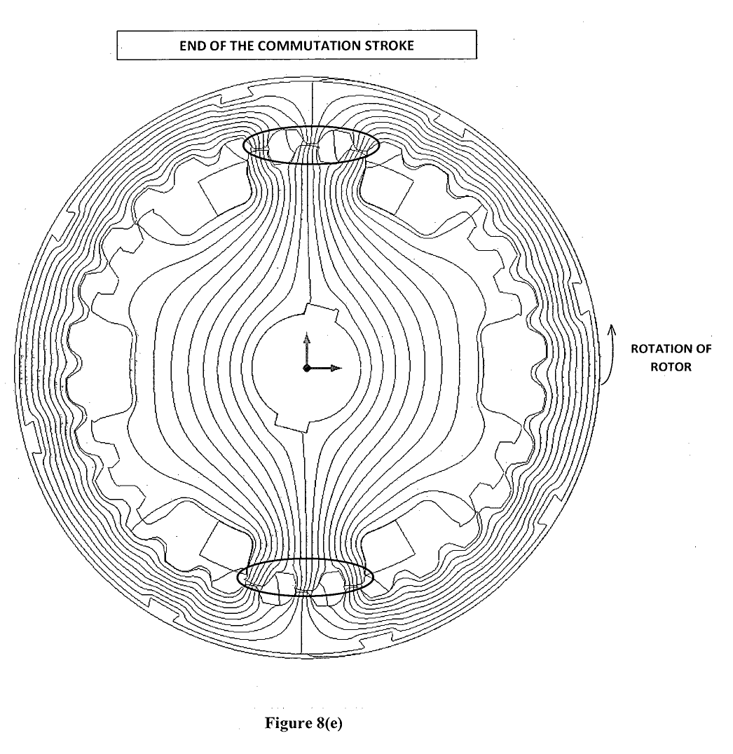

FIGS. 8(a) to 8(e) illustrate various representations of variation in the flux plot corresponding to a phase, at the start of commutation for anticlockwise rotation of the rotor of an inverted SRM assembly, according to one embodiment of the present invention. In particular, FIG. 8(a) shows a representation of flux plot for an inverted SRM assembly, when a phase is energized, according to one embodiment of the present invention. The flux plot shown corresponds to alignment of rotor poles 802 and stator poles 804 at the start of commutation. Similarly, FIGS. 8(b)-8(d) illustrate transitioning of flux plots corresponding to transitioning of alignment of the stator poles during a commutation stroke. FIG. 8(b) illustrates an exemplary flux representation at 25% completion of the commutation stroke, and FIGS. 8(c), 8(d) and 8(e) illustrate exemplary flux representations at 50%, 75% and 100% completion of commutation stroke respectively. After attaining the alignment at the completion of commutation stroke, illustrated in FIG. 8(e), the energized phase is switched off and is freewheeled while the rotor rotates further.

### Selection of Rotor Poles and Stator Poles:

For designing an SRM in accordance with an embodiment of the present invention, the following exemplary methodology may be used. Referring to the preceding embodiments of the invention, let P be the number of phases in the regular SRM or inverted SRM. The preferable value of P in various embodiments of the present invention is three or four. The number of stator poles is 2*P, while the number of sub-poles on each stator pole is NS and the desired angle of commutation be θ, then, the following relation is true.

P*NS*θ<360/(2*P) (1)

Here, the 180/P/θ is an integer value.
The number of rotor poles (NR) selected for three (3) or four (4) phases based on following equation 2:

NR=360/(P*θ) (2)

For a three phase SRM with smaller commutation angles, for example, when θ=12 degrees, the number of rotor poles will be 10. Similarly, with other values of commutation angles, the number of rotor poles NR has any of these values, viz. 12, 14, 16, 20, 22, 26, 28, 32 and for a four phase SRM assembly, the number of rotor poles NR has any of these values, viz. 10, 14, 18, 22, 26, 30, 34.

Once the configuration of the SRM assembly is determined with respect to number of stator poles, rotor poles, commutation angle, etc., the stator assembly is provided with a plurality of sub-poles at each of the stator poles. The number of sub-poles at each stator poles is determined based on value of commutation angle subtended by the sub-pole. Further, according to one exemplary embodiment of the present invention, the spacing between a pair of adjacent sub-poles of the plurality of sub-poles at a stator pole is two times the angle of commutation subtended by each of the sub-pole, when the SRM assembly is designed to work with three-phase. According to another exemplary embodiment of the present invention, the spacing between a pair of adjacent sub-poles of the plurality of sub-poles at a stator pole is three times the angle of commutation subtended by each of the sub-pole, when the SRM assembly is designed to work with four-phase.

The present invention further provides one or more structural features to enhance functioning of the SRM assembly, as illustrated above. An exemplary structural feature is provided herein below. On determining the number of stator poles, rotor poles and commutation angle, as discussed above, the SRM assembly may be designed with an enhanced commutation angle for obtaining better torque and torque density during its operation. In particular, the angle subtended by the rotor pole and the stator sub-poles at the center of rotation is conventionally designed to be θ degrees, however, on increasing the angle to θ+Δθ, the extra angle Δθ is utilized to drain-out the energy stored in an off-going phase while developing a positive torque.

An SRM assembly designed in accordance with the present invention utilizes only two coils per phase which are wound around the stator poles. Advantageously, by utilizing two coils per phase during operation of the SRM assembly, the resistance per phase, and net impedance reduces, and hence the required magneto-motive force (mmf) is reduced. With lower mmf requirement, the efficiency of the SRM assembly increases, thus resulting in high dynamic performance. This exemplary implementation strategy results in reduced torque ripple. The invented SRM assembly operates at commutation angle less than 15 degrees. In the SRM assembly provided in the present invention, the energy reuse at the aligned condition of the rotor and stator poles, reduces the complication of the energy management, torque ripple and improves efficiency. Further, the SRM assembly is designed to achieve greater material utilization by constructing a plurality of interlocked circumferentially-spaced outer stator and inner rotor segment assemblies and vice-versa.

Furthermore, the SRM assembly is designed to support a higher angle of commutation that generates a positive torque by freewheeling the phase through the angle of motion in excess of the required commutation angle. Therefore, the SRM assembly provides the advantage of, elimination of negative torque generated by an off going phase. Further, in the SRM a productive use of the energy of the off going phase is made by freewheeling the phase. This leads to the advantage of a reduction in the torque ripple of the SRM assembly. These distinct advantages are obtained with no addition of active control variables.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A Switched Reluctance Machine (SRM) assembly comprising:
a stator having a plurality of stator poles which are substantially angularly equally disposed, a surface of the stator interfacing with a rotor defining equal spaces between any of two adjacent stator poles, each of the plurality of stator poles comprising a plurality of sub-poles integrally formed therewith, the plurality of sub-poles providing the closest interface between the stator and the rotor, each stator pole comprising a coil with multiple turns wound thereon, wherein two stator coils wound around an opposing pair of stator poles are energized during an excitation phase which is configured to create a flux path between each of the plurality of opposing sub-poles of the energized stator poles of the SRM assembly; and
the rotor positioned with a means to provide for rotation, the rotor comprising a plurality of rotor poles extending from a surface to provide the closest interface between the rotor and stator, wherein an air-gap is created in between the stator sub-poles and the rotor poles, and wherein the plurality of stator sub-poles and the plurality of rotor poles are arranged to provide a commutation angle for the SRM assembly less than 15 degrees.

2. The SRM assembly as claimed in claim 1 comprising:
an outer stator comprising a substantially cylindrical inner surface having a plurality of inwardly extending stator poles which are substantially angularly equally disposed, the inner surface of the stator having equal spaces between any of two adjacent stator poles, wherein the plurality of stator poles comprises a plurality of sub-poles integrally formed therewith and disposed radially inwards, each stator pole comprising, a coil with multiple turns wound thereon, wherein two stator coils wound around an opposing pair of stator poles are energized during an excitation phase which is configured to create a flux path between each of the plurality of opposing sub-poles of the energized stator poles of the SRM assembly; and
an inner rotor positioned with a means to provide for rotation and maintain concentricity with the cylindrical hollow defined by the surface of the stator poles, the rotor comprising a plurality of rotor poles extending outwardly from an outer surface thereof, wherein an air-gap is created in between the inwardly extending sub-stator poles and the outwardly extending rotor poles, and wherein the plurality of sub-stator poles and the plurality of rotor poles are arranged to provide a commutation angle for the SRM assembly less than 15 degrees.

3. The SRM assembly as claimed in claim 1 comprising:
an inner stator comprising a substantially cylindrical outer surface having a plurality, of outwardly extending stator poles which are substantially angularly equally disposed, the outer surface of the stator having equal spaces between any of two adjacent stator poles, wherein the plurality of stator poles comprises a plurality of sub-poles integrally formed therewith and disposed radially outward, each stator poles comprising a coil with multiple turns wound thereon, wherein two stator coils wound around an opposing pair of stator poles are energized during an excitation phase which is configured to create a flux path between each of the plurality of opposing sub-poles of the energized stator poles of the SRM assembly; and
an outer rotor having a plurality of inwardly projected poles, the plurality of rotor poles thereby defining a hollow cylindrical inner space, and wherein the plurality of stator sub-poles and the rotor poles are arranged to provide a commutation angle for the SRM assembly less than 15 degrees,

4. The SRM assembly as claimed in claim 1, wherein the flux path created between each of the plurality of opposing sub-poles of the energized opposing pair of stator poles comprises of substantially parallel flux paths for flux transiting in air between the energized pair of stator poles.

5. The SRM assembly as claimed in claim 1, wherein the product of number of sub-poles on each stator pole, the desired angle of commutation, and number of phases required in the operation of the SRM assembly is less than three sixty degrees divided by number of stator poles.

6. The SRM assembly as claimed in claim 5, wherein three hundred and sixty degrees divided by the product of the number of phases and the desired angle of commutation is equal to number of rotor poles in the assembly.

7. The SRM assembly as claimed in claim 1, wherein the plurality of stator poles and the plurality of rotor poles are structured in the SRM assembly by increasing the required angle of commutation with an additional angle value, and wherein the additional angle value facilitates dissipation of energy stored in an off going energized phase by free-wheeling the off going energized phase.

8. The SRM assembly as claimed in claim 1, wherein the plurality of stator sub-poles and the plurality of rotor poles are designed into multiple shapes to achieve a higher torque during operation of the SRM assembly.

9. The SRM assembly as claimed in claim 1, wherein the SRM assembly is designed to work with three phases, each sub-pole subtending an angle of commutation at the centre of the SRM assembly, and the spacing between a pair of adjacent sub-poles of the plurality of sub-poles at a stator pole is two times the angle of commutation subtended by each of the sub-pole.

10. The SRM assembly as claimed in claim 1, wherein the SRM assembly is designed to work with four phases, each sub-pole subtending an angle of commutation at the centre of the SRM assembly, and the spacing between a pair of adjacent sub-poles of the plurality, of sub-poles at a stator pole is three times the angle of commutation subtended by each of the sub-pole.

11. The SRM assembly as claimed in claim 1, wherein the SRM assembly is operated as a motor.

12. The SRM assembly as claimed in claim 1, wherein the SRM assembly is operated as a generator.

13. The SRM assembly as claimed in claim 1, wherein the SRM assembly is operated as a combination of motor and generator.

14. The SRM assembly as claimed in claim 1, wherein the SRM assembly is designed to operate as a sensor-less SRM.

15. The SRM assembly as claimed in claim 1, wherein the SRM assembly is designed to operate with a sensor.

16. The SRM assembly as claimed in claim 1, wherein the SRM assembly is designed to achieve greater material utilization by constructing a plurality of interlocked circumferentially-spaced stator segment assemblies with a stator segment core and winding wire wound or placed around each of the plurality of stator poles, wherein the rotor surface assemblies are segmented.

17. A Switched Reluctance Machine (SRM) assembly, wherein the SRM assembly is designed to work with three phases, the SRM assembly comprising:
a stator comprising a plurality of stator poles which are substantially angularly equally disposed, a surface of the stator interfacing with a rotor defining equal spaces between any of two adjacent stator poles, the plurality of stator poles comprising a plurality of sub-poles integrally formed therewith, the plurality of sub-poles providing the closest interface between the stator and rotor, each stator pole comprising a coil with multiple turns wound thereon, each sub-pole subtending an angle of commutation at the centre of the SRM assembly, wherein the spacing between a pair of adjacent sub-poles of the plurality of sub-poles at a stator pole is two times the angle of commutation subtended by each of the sub-pole; and
the rotor comprising a plurality of rotor poles extending from a surface to provide the closest interface between the rotor and the stator.

18. A Switched Reluctance Machine (SRM) assembly, wherein the SRM assembly is designed to work with four phases, the SRM assembly comprising:
a stator comprising a plurality of stator poles which are substantially angularly equally disposed, a surface of the stator interfacing with a rotor defining equal spaces between any of two adjacent stator poles, the plurality of stator poles comprising a plurality of sub-poles integrally formed therewith, the plurality of sub-poles providing the closest interface between the stator and rotor, each sub-pole subtending an angle of commutation at the centre of the SRM assembly, wherein the spacing between a pair of adjacent sub-poles of the plurality of sub-poles at a stator pole is three times the angle of commutation subtended by each of the sub-pole; and
the rotor comprising a plurality of rotor poles extending from a surface to provide the closest interface between the rotor and the stator.
